(19) United States
(12) Patent Application Publication
(10) Pub. No.: US 2013/0153054 A1
(43) Pub. Date: Jun. 20, 2013

(54) Combinatorial Processing Tool

(71) Applicants: Kent Riley Child, Dublin, CA (US); Tony P. Chiang, Campbell, CA (US)

(72) Inventors: Kent Riley Child, Dublin, CA (US); Tony P. Chiang, Campbell, CA (US)

(73) Assignee: Intermolecular, Inc., San Jose, CA (US)

(21) Appl. No.: 13/330,149

(22) Filed: Dec. 19, 2011

(51) Int. Cl. F16L 3/00; B25B 11/00

(52) U.S. Cl. 137/343; 269/21

(57) ABSTRACT

A combinatorial processing chamber is provided. The processing chamber includes a substrate support rotatable around a central axis. The substrate support has a plurality of subsections operable to be isolated from each other. The plurality of subsections has a rotatable support cell independently controllable from the substrate support. A vacuum source in fluid communication with a gap defined around a peripheral region of the substrate support is provided. The vacuum source is in fluid communication with a peripheral region of each rotatable support cell of the plurality of subsections.

### FIELD OF INVENTION

The embodiments relate to a semiconductor processing tool.

### BACKGROUND

Combinatorial processing may refer to various techniques used to vary characteristics of the processes applied to multiple regions of a substrate in serial, parallel or parallel-serial fashion. Combinatorial processing may be used to test and compare multiple and various processing techniques. The processing techniques may be validated, and those techniques that are useful may be applied to, for example, different substrates or full-substrate processing.

In a combinatorial processing system, the processing tool becomes more valuable when the tool is capable of offering enhanced processing flexibility. The ability to perform different experiments contemporaneously on the same substrate decreases the process development cycle. In addition, the ability to independently vary process parameters, such as temperature, within sections of the process tool, along with the capability to perform independent layering of material on substrates under macro and micro processes is desirable from a research perspective.

It is within this context that the embodiments arise.

### SUMMARY

Embodiments of the present invention provide a system and method for processing a substrate. Several inventive embodiments of the present invention are described below.

In some embodiments, a processing chamber is provided. The processing chamber includes a substrate support rotatable around a central axis. The substrate support has a plurality of subsections operable to be isolated from each other. The plurality of subsections has a rotatable cell independently controllable from the substrate support. A vacuum source in fluid communication with a gap defined around a peripheral region of the substrate support is provided. The vacuum source is in fluid communication with a peripheral region of each rotatable cell of the plurality of subsections.

In some embodiments, a processing chamber is provided. The processing chamber includes a substrate support rotatable around a central axis, the substrate support having a plurality of subsections operable to be isolated from each other. A plurality of coils is included. Each one of the plurality of coils is disposed under a corresponding one of the plurality of subsections of the substrate support. Each of the plurality of coils is independently operable to generate a magnetic field when supplied with a current. A channel is disposed around a periphery of each of the plurality of subsections. The channel is operable to radiate heat away from an adjacent sub section.

Other aspects of the invention will become apparent from the following detailed description, taken in conjunction with the accompanying drawings, illustrating by way of example the principles of the invention.

### BRIEF DESCRIPTION OF DRAWINGS

FIG. 1 illustrates a schematic diagram for implementing combinatorial processing and evaluation using primary, secondary, and tertiary screening.

FIG. 2 is a simplified schematic diagram illustrating a general methodology for combinatorial process sequence integration.

FIG. 3 is a simplified schematic diagram illustrating an integrated high productivity combinatorial (HPC) system in accordance with some embodiments of the invention

FIG. 4A is a simplified schematic diagram illustrating a combinatorial processing chamber in accordance with some embodiments of the invention.

FIG. 4B is a simplified schematic diagram illustrating a cross-sectional view of a combinatorial processing chamber in accordance with some embodiments of the invention.

FIG. 4C is a simplified schematic diagram illustrating a cross-sectional view of the substrate support of the combinatorial processing system in accordance with some embodiments of the invention.

FIG. 5 is a simplified schematic diagram illustrating a cross-sectional view of a combinatorial processing system with subsections of a substrate support isolated from each other in accordance with some embodiments of the invention.

FIG. 6A is a simplified schematic diagram illustrating a perspective view of a substrate support having independent heating capability for subsections of the substrate support in accordance with some embodiments of the invention.

FIG. 6B is a simplified schematic diagram illustrating a cross-sectional view of a substrate support having independent heating capability for subsections of the substrate support in accordance with some embodiments of the invention.

### DETAILED DESCRIPTION

The embodiments described herein provide a method and apparatus related to semiconductor processing. It will be obvious, however, to one skilled in the art, that the present invention may be practiced without some or all of these specific details. In other instances, well known process operations have not been described in detail in order not to unnecessarily obscure the present invention.

The embodiments described a substrate processing chamber having a substrate support in which subsections of the substrate support are independently rotatable and independently heated. In one embodiment the substrate support is divided into quadrants where the entire substrate support can rotate around a central axis and each quadrant includes a rotatable support which can independently rotate around its own central axis. Each quadrant is capable of defining an independent processing environment that can perform combinatorial processing. Within each quadrant it is possible to further define sub-quadrants that can also be independently rotatable. Process gas is supplied to each quadrant through a lid of the process chamber in a laminar manner and exits through an annular ring having a cavity or gap to a sub-chamber where vacuum is applied. Vacuum is additionally applied through a peripheral annular ring disposed below the substrate support for the full substrate processing. The embodiments enable independent film processing in each subsection and also capable of performing conventional full substrate processing. Thus, independent layering for micro and macro processes may be performed through the embodiments described below. That is, each small chamber can independently be isolated for independent processing of small chambers and thereafter each of the small chambers can be opened up for total macro processing of all chambers within a single chamber. In some embodiments, independent inductive heating is applied for each subsection.

Semiconductor manufacturing typically includes a series of processing steps such as cleaning, surface preparation, deposition, patterning, etching, thermal annealing, and other related unit processing steps. The precise sequencing and integration of the unit processing steps enables the formation of functional devices meeting desired performance metrics such as efficiency, power production, and reliability.

As part of the discovery, optimization and qualification of each unit process, it is desirable to be able to i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices such as integrated circuits. In particular, there is a need to be able to test i) more than one material, ii) more than one processing condition, iii) more than one sequence of processing conditions, iv) more than one process sequence integration flow, and combinations thereof, collectively known as “combinatorial process sequence integration”, on a single monolithic substrate without the need of consuming the equivalent number of monolithic substrates per material(s), processing condition(s), sequence(s) of processing conditions, sequence(s) of processes, and combinations thereof. This can greatly improve both the speed and reduce the costs associated with the discovery, implementation, optimization, and qualification of material(s), process(es), and process integration sequence(s) required for manufacturing.

Systems and methods for High Productivity Combinatorial (HPC) processing are described in U.S. Pat. No. 7,544,574 filed on Feb. 10, 2006, U.S. Pat. No. 7,824,935 filed on Jul. 2, 2008, U.S. Pat. No. 7,871,928 filed on May 4, 2009, U.S. Pat. No. 7,902,063 filed on Feb. 10, 2006, and U.S. Pat. No. 7,947,531 filed on Aug. 28, 2009 which are all herein incorporated by reference. Systems and methods for HPC processing are further described in U.S. patent application Ser. No. 11/352,077 filed on Feb. 10, 2006, claiming priority from Oct. 15, 2005, U.S. patent application Ser. No. 11/419,174 filed on May 18, 2006, claiming priority from Oct. 15, 2005, U.S. patent application Ser. No. 11/674,132 filed on Feb. 12, 2007, claiming priority from Oct. 15, 2005, and U.S. patent application Ser. No. 11/674,137 filed on Feb. 12, 2007, claiming priority from Oct. 15, 2005 which are all herein incorporated by reference.

HPC processing techniques have been successfully adapted to wet chemical processing such as etching and cleaning. HPC processing techniques have also been successfully adapted to deposition processes such as physical vapor deposition (PVD), atomic layer deposition (ALD), and chemical vapor deposition (CVD).

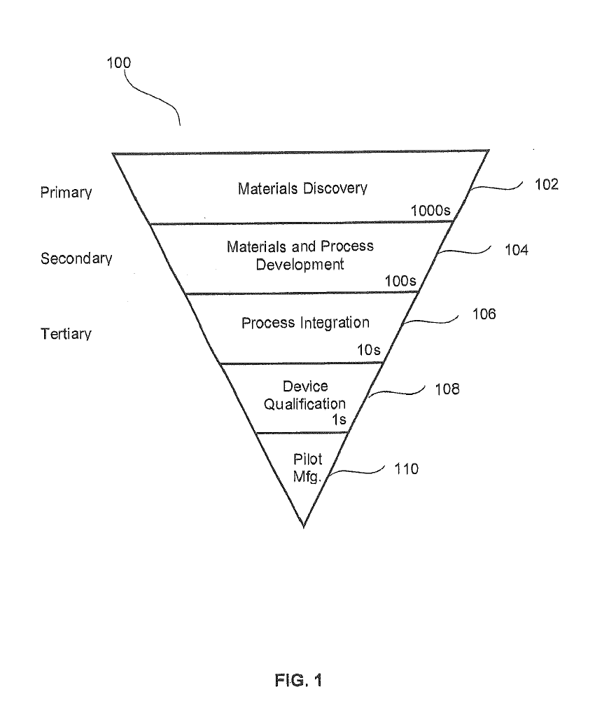

FIG. 1 illustrates a schematic diagram, 100, for implementing combinatorial processing and evaluation using primary, secondary, and tertiary screening. The schematic diagram, 100, illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

For example, thousands of materials are evaluated during a materials discovery stage, 102. Materials discovery stage, 102, is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage, 104. Evaluation of the materials is performed using metrology tools such as electronic testers and imaging tools (i.e., microscopes).

The materials and process development stage, 104, may evaluate hundreds of materials (i.e., a magnitude smaller than the primary stage) and may focus on the processes used to deposit or develop those materials. Promising materials and processes are again selected, and advanced to the tertiary screen or process integration stage, 106, where tens of materials and/or processes and combinations are evaluated. The tertiary screen or process integration stage, 106, may focus on integrating the selected processes and materials with other processes and materials.

The most promising materials and processes from the tertiary screen are advanced to device qualification, 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing, 110.

The schematic diagram, 100, is an example of various techniques that may be used to evaluate and select materials and processes for the development of new materials and processes. The descriptions of primary, secondary, etc. screening and the various stages, 102-110, are arbitrary and the stages may overlap, occur out of sequence, be described and be performed in many other ways.

This application benefits from High Productivity Combinatorial (HPC) techniques described in U.S. patent application Ser. No. 11/674,137 filed on Feb. 12, 2007 which is hereby incorporated for reference in its entirety. Portions of the '137 application have been reproduced below to enhance the understanding of the present invention. The embodiments described herein enable the application of combinatorial techniques to process sequence integration in order to arrive at a globally optimal sequence of semiconductor manufacturing operations by considering interaction effects between the unit manufacturing operations, the process conditions used to effect such unit manufacturing operations, hardware details used during the processing, as well as materials characteristics of components utilized within the unit manufacturing operations. Rather than only considering a series of local optimums, i.e., where the best conditions and materials for each manufacturing unit operation is considered in isolation, the embodiments described below consider interactions effects introduced due to the multitude of processing operations that are performed and the order in which such multitude of processing operations are performed when fabricating a device. A global optimum sequence order is therefore derived and as part of this derivation, the unit processes, unit process parameters and materials used in the unit process operations of the optimum sequence order are also considered.

The embodiments described further analyze a portion or sub-set of the overall process sequence used to manufacture a semiconductor device. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate that are equivalent to the structures formed during actual production of the semiconductor device. For example, such structures may include, but would not be limited to, contact layers, buffer layers, absorber layers, or any other series of layers or unit processes that create an intermediate structure found on semiconductor devices. While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameter (e.g., materials, unit processes, unit process parameters, hardware details, or process sequences) and not the lack of process uniformity. In the embodiments described herein, the positions of the discrete regions on the substrate can be defined as needed, but are preferably systematized for ease of tooling and design of experimentation. In addition, the number, variants and location of structures within each region are designed to enable valid statistical analysis of the test results within each region and across regions to be performed.

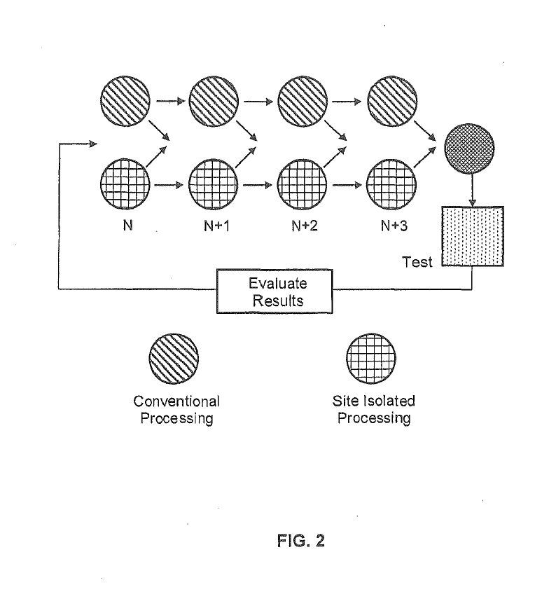

FIG. 2 is a simplified schematic diagram illustrating a general methodology for combinatorial process sequence integration that includes site isolated processing and/or conventional processing in accordance with one embodiment of the invention. In one embodiment, the substrate is initially processed using conventional process N. In one exemplary embodiment, the substrate is then processed using site isolated process N+1. During site isolated processing, an HPC module may be used, such as the HPC module described in U.S. patent application Ser. No. 11/352,077 filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in semiconductor manufacturing may be varied.

As mentioned above, within a region, the process conditions are substantially uniform, in contrast to gradient processing techniques which rely on the inherent non-uniformity of the material deposition. That is, the embodiments, described herein locally perform the processing in a conventional manner, e.g., substantially consistent and substantially uniform, while globally over the substrate, the materials, processes, and process sequences may vary. Thus, the testing will find optimums without interference from process variation differences between processes that are meant to be the same. It should be appreciated that a region may be adjacent to another region in one embodiment or the regions may be isolated and, therefore, non-overlapping. When the regions are adjacent, there may be a slight overlap wherein the materials or precise process interactions are not known, however, a portion of the regions, normally at least 50% or more of the area, is uniform and all testing occurs within that region. Further, the potential overlap is only allowed with material of processes that will not adversely affect the result of the tests. Both types of regions are referred to herein as regions or discrete regions.

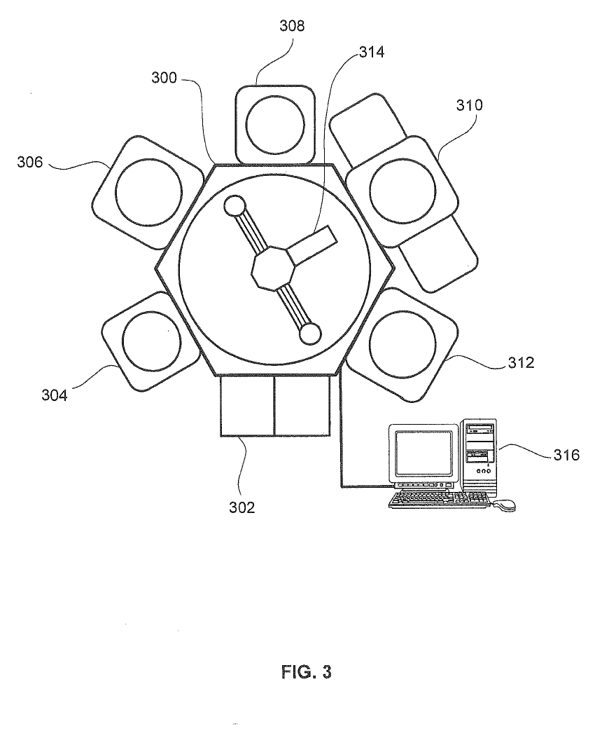

FIG. 3 is a simplified schematic diagram illustrating an integrated high productivity combinatorial (HPC) system in accordance with some embodiments of the invention. HPC system includes a frame 300 supporting a plurality of processing modules. It should be appreciated that frame 300 may be a unitary frame in accordance with some embodiments. In some embodiments, the environment within frame 300 is controlled. Load lock/factory interface 302 provides access into the plurality of modules of the HPC system. Robot 314 provides for the movement of substrates (and masks) between the modules and for the movement into and out of the load lock 302. Modules 304-312 may be any set of modules and preferably include one or more combinatorial modules. For example, module 304 may be an orientation/degassing module, module 306 may be a clean module, either plasma or non-plasma based, modules 308 and/or 310 may be combinatorial/conventional dual purpose modules. Module 312 may provide conventional clean or degas as necessary for the experiment design.

Any type of chamber or combination of chambers may be implemented and the description herein is merely illustrative of one possible combination and not meant to limit the potential chamber or processes that can be supported to combine combinatorial processing or combinatorial plus conventional processing of a substrate or wafer. In some embodiments, a centralized controller, i.e., computing device 316, may control the processes of the HPC system, including the power supplies and synchronization of the duty cycles described in more detail below. Further details of one possible HPC system are described in U.S. application Ser. Nos. 11/672,478 and 11/672,473. With HPC system, a plurality of methods may be employed to deposit material upon a substrate employing combinatorial processes.

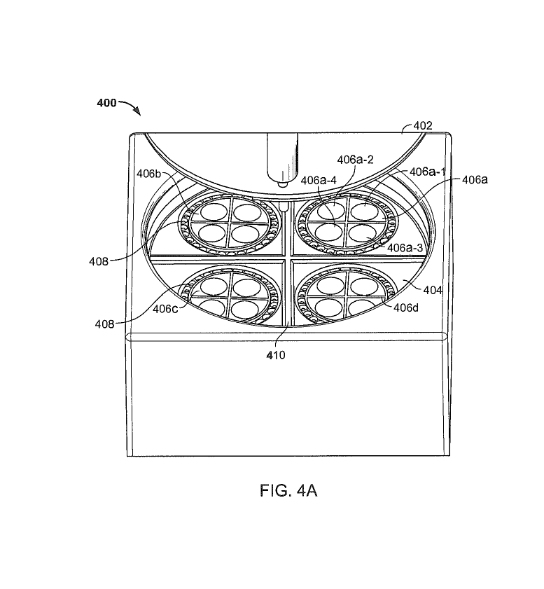

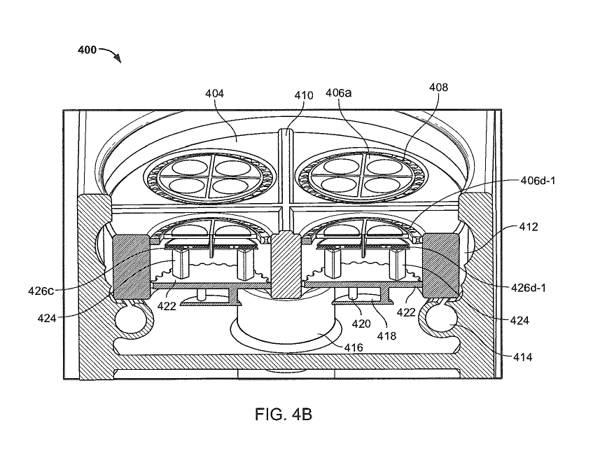

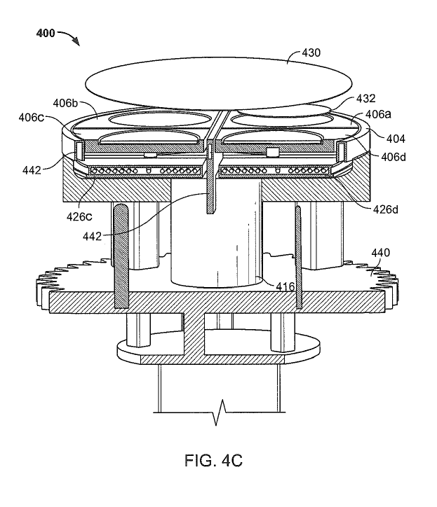

FIG. 4A is a simplified schematic diagram illustrating a combinatorial processing chamber in accordance with some embodiments of the invention. Combinatorial processing chamber 400 includes a lid 402 which is configured to mate or seal with an opening of the processing chamber. Lid 402 may be affixed to the processing chamber through any known means. Substrate support 404 includes a plurality of subsections 406a through 406d. Subsections 406 a through 406d are configured to be isolated from each other during a processing operation. In some embodiments, lid 402 includes extensions that mate with ridge 410 in order to isolate subsections 406a through 406d. In alternative embodiments a substrate may be processed conventionally, i.e., the entire substrate may be disposed over substrate support 404 without isolation of subsections. Each of subsections 406a through 406d is further subdivided into a plurality of cells. For example, subsection 406a is subdivided into cells 406a-1 through 406a-4. Subsections 406b through 406d are similarly subdivided but are not illustrated in FIG. 4A in order to not obscure the details. In some embodiments, each of the cells 406a-1 through 406a-4 are independently rotatable. In some embodiments, water or air powered motors may be utilized to provide the control for the cells. As illustrated in more detail below subsections 406a through 406d are also independently rotatable. It should be appreciated that substrate support 404 is rotatable around a central axis of substrate support 404 in some embodiments. Each of subsections 406a through 406d has a peripheral region 408 with a plurality of apertures extending through the thickness of substrate support 404. In addition, around a peripheral edge of substrate support 404 a gap exists where vacuum supplied from a lower surface of a combinatorial processing chamber 400. It should be appreciated that the configuration with vacuum access around the peripheral regions of each of the subsections 406a through 406d and the peripheral region of substrate support 404 insurers laminar flow for process fluids originating from above the substrates or substrate disposed in corresponding subsections 406a through 406d or over the entire substrate support 404.

FIG. 4B is a simplified schematic diagram illustrating a cross-sectional view of a combinatorial processing chamber in accordance with some embodiments of the invention. A lower portion of a combinatorial processing chamber 400 is illustrated in the cross-sectional view of FIG. 4B. Housing 416 houses a drive configured to rotate substrate support 404 around a central axis in some embodiments. Drive 420, which is affixed to plate 418, is configured to rotate support plate 422, which is subsequently coupled to subsection 406d in accordance with some embodiments. Support plate 422 lifts 424 disposed on a top surface of support plate 422. Lifts 424 are operable to vertically raise or lower heating subsections to which the corresponding lifts are coupled. Lift 424 is illustrated coupled to heating subsection 426d-1 which is disposed below cell 406d-1. It should be appreciated that the remainder of lifts 424 illustrated in FIG. 4B are similarly situated. Lifts 424 may utilize any known style of motion, such as externally through vacuum feed-throughs or in-vacuum linear lifts. Support plates 422 are illustrated with an uneven peripheral edge in order to enable vacuum access to the peripheral region 408 and the respective apertures of each corresponding subsection. Vacuum channel 414 is defined around a peripheral lower region of processing chamber 400. It should be appreciated that vacuum channel 414 is in fluid communication with the vacuum source. Vacuum channel 414 has an upper opening which is in fluid communication with gap 412 defined around a peripheral region of substrate support 404.

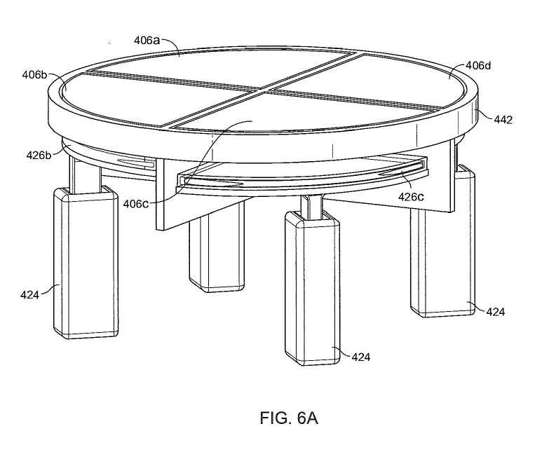

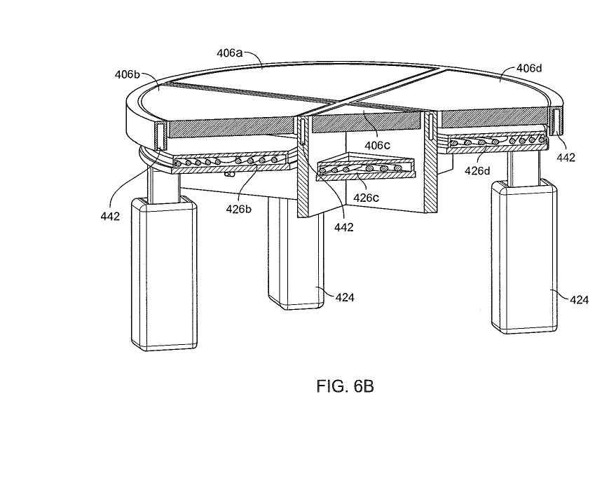

FIG. 4C is a simplified schematic diagram illustrating a cross-sectional view of the substrate support of the combinatorial processing system in accordance with some embodiments of the invention. In the embodiment of FIG. 4C independent heating is provided for each of subsections 406a through 406d. It should be appreciated that the independent heating illustrated in FIG. 4C may be optionally combined with the independent rotation illustrated in FIGS. 4A and 4B of the various subsections and cells of the substrate support of the combinatorial processing system. In alternative embodiment, the independent heating may be utilized without independent rotation of the subsections as illustrated in FIGS. 6A and 6B. Combinatorial processing system 400 is provided with heating subsections 426c and 426d. It should be appreciated that heating subsections disposed under subsection 406a and 406b are not shown for ease of illustration. Housing 416 may house a drive operable to rotate substrate support 404 around a central axis of the substrate support. It should be further appreciated that the drive for substrate support 404 may be alternatively disposed below plate 440. Plate 440 includes an uneven peripheral edge in order to enable vacuum access to the periphery of substrate support 404 from a lower region of the process chamber. Channel 442 is provided around substrate support 404 and between each of sub sections 406a through 406d in order to thermally isolate each of subsections. In some embodiments, channel 442 is composed of a reflective material that radiates heat energy and prevents the heat energy from being transferred to an adjacent subsection. In other embodiments, a fluid from an external fluid source may flow through channel 442.

Substrates 430 and 432 are illustrated above substrate support 404 in FIG. 4C. As illustrated, a smaller substrate 432 may be processed within one of subsections 406a through 406d. In alternative embodiments, a larger substrate 430 may be processed in a conventional processing technique or a combinatorial processing technique through the processing system of FIG. 4C. Thus, the embodiments enable a plurality of smaller substrates to be contemporaneously processed in a combinatorial or conventional manner. In addition, a larger substrate may be processed with different regions of the larger substrate processed differently or an entire uniform layer can be deposited on a surface of the larger substrate. Consequently, the embodiments described herein provide for independent layering of small or large substrates in the incorporation of macro processes and micro-processes within a single processing unit. While the embodiments illustrate the substrate support and the sub sections divided into quadrants, this is not meant to be limiting as the substrate support and the sub sections may be divided into more or less segments.

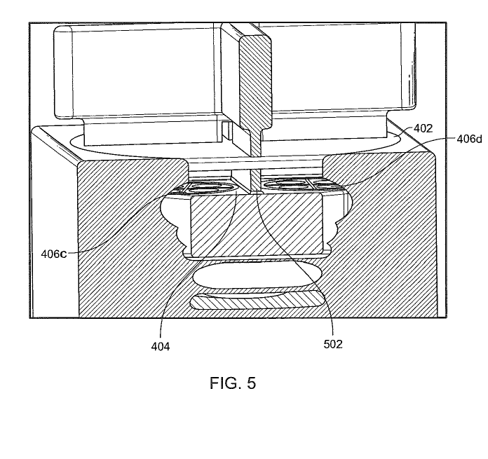

FIG. 5 is a simplified schematic diagram illustrating a cross-sectional view of a combinatorial processing system with subsections of a substrate support isolated from each other in accordance with some embodiments of the invention. Substrate support 404 is illustrated with isolated subsections 406c and 406d. Isolated subsections 406c and 406d are isolated from each other through barrier 502 which is integrated into a lid 402 in accordance with some embodiments. In some embodiments, barrier 502 may mate with the channel that thermally isolates the subsections of the substrate support. It should be appreciated that lid 402 may be replaced with an alternative configuration when a full wafer is being processed with a layer being deposited over an entirety of the surface of the full wafer. In such an embodiment, the isolated subsections defined by the mating of barrier 502 with a surface of substrate support 404, is unnecessary.

FIG. 6A is a simplified schematic diagram illustrating a perspective view of a substrate support having independent heating capability for subsections of the substrate support in accordance with some embodiments of the invention. Heating subsections 426b and 426c are illustrated disposed below corresponding subsections 406b and 406c of the substrate support. Drives 424 for each of the heating subsections provide the ability to vertically move the heating subsections relative to a bottom surface of a corresponding subsection of the substrate support in order to control the temperature provided to the substrate. Channel 442 is defined around a periphery of each of subsections 406a through 406d.

FIG. 6B is a simplified schematic diagram illustrating a cross-sectional view of a substrate support having independent heating capability for subsections of the substrate support in accordance with some embodiments of the invention. Heating subsections 426b through 426d are illustrated with coils disposed therein. In one embodiment, the coils are liquid cooled inductor coils. It should be appreciated that the liquid cooled inductor coils are configured to induce eddy currents in the substrate support in order to heat the substrate support, which in turn heats a substrate disposed on a surface of the substrate support. In this configuration, heat can be varied individually by utilizing separate power sources for each coil. In some embodiments the substrate support may be referred to as a susceptor and is a material that absorbs electromagnetic material and converts it to heat. A description of an exemplary susceptor and coils may be found in U.S. patent application Ser. No. 12/963,425 entitled “Induction Heating for Substrate Processing” filed on Jun. 15, 2011 which is herein incorporated by reference. In addition channel 442 enables utilization of a purge plenum that has a reflective surface to radiate heat away from adjacent subsections and thus insulate the subsections from each other. It should be appreciated that the control for the lifts 424, as well as the rotation of the substrate support, sub section of the substrate support and the cells, may be provided through the computing device of FIG. 3 in some embodiments.

The drawings, like reference numerals appearing in different drawings represent similar or same components and perform similar or same functions, unless specifically noted otherwise in the description. Furthermore, as would be appreciated by those skilled in the art, according to common practice, the various features of the drawings discussed herein are not necessarily drawn to scale, and that dimensions of various features, structures, or characteristics of the drawings may be expanded or reduced to more clearly illustrate various implementations of the invention described herein.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

1. A processing chamber, comprising:
a substrate support having a central axis,
the central axis being perpendicular to a plane of the substrate support,
the substrate support being rotatable around the central axis,
the substrate support having a plurality of subsections operable to be physically isolated from each other,
each of the plurality of subsections comprising a rotatable cell,
each rotatable cell independently controllable from the substrate support; and
a first gap defined around a peripheral region of the substrate support;
a plurality of second gaps, each second gap defined around a peripheral region of one of the rotatable cells;
a vacuum source in fluid communication with the first gap and each of the plurality of second gaps.

2. The processing chamber of claim 1 wherein each of the plurality of subsections has independent temperature control.

3. The processing chamber of claim 1, further comprising:
a coil disposed under the substrate support, the coil operable to generate a magnetic field when supplied with a current.

4. The processing chamber of claim 1, further comprising:
a plurality of coils, each one of the plurality of coils disposed under a corresponding of the plurality of subsections of the substrate support, each of the plurality of coils independently operable to generate a magnetic field when supplied with a current.

5. The processing chamber of claim 4, wherein each of the plurality of coils is independently moveable in a vertical direction.

6. The processing chamber of claim 1, further comprising:
a lid operable to isolate each of the plurality of subsections from each other.

7. The processing chamber of claim 6, wherein process fluids are supplied to the processing chamber through the lid.

8. The processing chamber of claim 1, wherein each of the plurality of rotatable cells has independent temperature control.

9. The processing chamber of claim 1, wherein each rotatable cell has a plurality of openings disposed around a peripheral region of each rotatable cell.

10. A processing chamber, comprising:
a substrate support having a central axis,
the central axis being perpendicular to a plane of the substrate support,
the substrate support being rotatable around the central axis,
the substrate support having a plurality of subsections operable to be physically isolated from each other;
a plurality of coils,
each one of the plurality of coils disposed under a corresponding one of the plurality of subsections of the substrate support,
each of the plurality of coils independently operable to generate a magnetic field when supplied with a current; and
a channel disposed around a periphery of each of the plurality of subsections,
the channel operable to radiate heat away from an adjacent subsection.

11. The chamber of claim 10, wherein each of the plurality of subsections have a rotatable cell independently controllable from the substrate support.

12. The chamber of claim 11, further comprising:
a vacuum source in fluid communication with a first gap defined around a peripheral region of the substrate support, the vacuum source in fluid communication with a plurality of second gaps, the second gaps defined around a peripheral region of each of the rotatable cells.

13. The chamber of claim 10, wherein each of the plurality of coils are independently moveable relative to a surface of the substrate support.

14. The chamber of claim 10 further comprising:
a lid, the lid operable to isolate the plurality of subsections from each other.

15. The chamber of claim 10, further comprising:
a first drive operable to rotate the substrate support; and
a plurality of second drives, each one of the plurality of second drives operable to rotate a corresponding one of the plurality of cells.

16. The chamber of claim 10, wherein the channel is purged with a fluid.

17. The chamber of claim 11, wherein each rotatable cell has a plurality of openings disposed around a peripheral region of each rotatable support cell.
